(19) United States
(12) Patent Application Publication
(10) Pub. No.: US 2024/0074454 A1
(43) Pub. Date: Mar. 7, 2024

(54) METHOD OF PRODUCING A MEAT ANALOGUE

(71) Applicant: BEVO, BIOTEHNOLOŠKE REŠITVE D.O.O., Domžale (SL)

(72) Inventors: Hrovat MAJ, Radomlje (SI); Luka SINCEK, Tolmin (SI); Rok MEJAŠ, Šentrupert (SI); Tilen TRAVNIK, Kamnik (SI)

(21) Appl. No.: 18/261,346

(22) PCT Filed: Jan. 19, 2022
(86) PCT No.: PCT/IB2022/000078

§ 371 Date: Jul. 13, 2023

Related U.S. Application Data
(60) Provisional application No. 63/139,349, filed on Jan. 20, 2021.

(30) Foreign Application Priority Data
Jan. 20, 2021 (GB) 2100719.0

(51) Int. Cl. A23J 3/22; A23J 3/16; A23J 3/26

(52) U.S. Cl. CPC A23J 3/227; A23J 3/16; A23J 3/26

(57) ABSTRACT

The present application provides a method of producing a meat analogue, for example a meat analogue produced from a vegetable protein. The method comprises forming a fibrous muscle tissue analogue by high-temperature texturisation of a base material comprising a non-animal derived protein. The high-temperature texturisation is configured to cause denaturing of the non-animal derived protein and formation of substantially parallel fibres in the fibrous muscle tissue analogue. The method further includes partially separating at least some of the fibres of the fibrous muscle tissue analogue. Also disclosed is apparatus for producing a meat analogue, a meat analogue, and a method of producing a meat analogue by binding together two or more fibrous muscle tissue analogues.

This invention relates to methods of producing a meat analogue, apparatus for producing a meat analogue, and a meat analogue.

### BACKGROUND

Meat production and consumption can be harmful for the environment and health, so meat alternatives produced from non-animal-derived ingredients are of growing importance and popularity. Some technological solutions have been developed to provide plant-based meat alternatives. Plant-based meat alternatives beneficially provide consumers with similar products and experiences to meat and so reduce the need to change consumer behaviour.

It is known to produce a meat analogue from vegetable protein, such as soy protein concentrates. A fibrous meat analogue can be made by texturising the vegetable protein by applying shear under heat and pressure, or by applying shear forces to create laminar flows and at the same time triggering enzymatic crosslinking. Texturisation may be created by extrusion, where a high moisture vegetable protein is heated and forced through a die. The heat and pressure cause protein denaturation and the formation of a fibrous protein gel where the fibres are generally aligned in the direction of extrusion. Shear cell texturising uses a heated rotating cylinder and a stationary cylinder to apply heat and shear forces to the vegetable protein to form fibres.

Although existing processes have had some success with creating minced meat analogues, they have not been able to produce whole cut meat analogues with a combination of taste, appearance, and texture that matches the experience of eating animal meat tissue.

### BRIEF SUMMARY OF THE DISCLOSURE

In accordance with the present disclosure there is provided a method of producing a meat analogue, the method comprising:
forming a fibrous muscle tissue analogue by high-temperature texturisation of a base material comprising a non-animal derived protein, the high-temperature texturisation configured to cause denaturing of the non-animal derived protein and formation of substantially parallel fibres in the fibrous muscle tissue analogue; and
partially separating at least some of the fibres of the fibrous muscle tissue analogue.

Separation of the fibres of the fibrous muscle tissue analogue advantageously improves the texture of the meat analogue, making it more similar to that of animal meat. In addition, separation of the fibres of the fibrous muscle tissue analogue provides for improved marinating, flavouring, and cooking.

In examples, after partially separating at least some of the fibres of the fibrous muscle tissue analogue the fibres remain substantially parallel to one another. In examples, after partially separating at least some of the fibres of the fibrous muscle tissue analogue the fibrous muscle tissue analogue remains as a single, unified body, for example a sheet or slab. That is, the fibres are only partially separated such that the fibrous muscle tissue analogue remains intact as a single element. Advantageously, this provides a method of producing a whole cut meat analogue having a texture similar to that of muscle tissue.

In examples, forming a fibrous muscle tissue analogue by high-temperature texturisation comprises applying shear stresses to the base material. In examples, high-temperature texturisation comprises high-moisture texturisation. In examples, forming a fibrous muscle tissue analogue by high-temperature texturisation comprises one of:
extruding the base material through a die, or
shearing the base material in a shear cell.

In various examples, the fibrous muscle tissue analogue may be formed by high moisture extrusion, low moisture extrusion, or shear cell processing.

In examples, partially separating at least some of the fibres of the fibrous muscle tissue analogue comprises compressing the fibrous muscle tissue analogue. For example, compressing the fibrous muscle tissue analogue may comprise one of:
passing the fibrous muscle tissue analogue through a roller arrangement arranged to compress the fibrous muscle tissue analogue, or
pressing the fibrous muscle tissue analogue using a press.

In examples, partially separating at least some of the fibres of the fibrous muscle tissue analogue reduces the thickness of the fibrous muscle tissue analogue. The thickness of the fibrous muscle tissue analogue after partially separating at least some of the fibres may be between about 0.5 mm and about 10 mm, for example less than about 10 mm, for example less than about 8 mm, for example about 5 mm.

In examples, the method may further comprise marinating the fibrous muscle tissue analogue after separation of the fibres of the fibrous muscle tissue analogue. Marinating the fibrous muscle tissue analogue may comprise spraying or brushing a marinade onto the fibrous muscle tissue analogue, or passing the fibrous muscle tissue analogue through a marinade bath. The marinade may comprise water and one or more of a flavouring, a colouring, a flavour precursor, a preservative, a spice, and an oil. The marinade is preferably absorbed into the fibres of the fibrous muscle tissue analogue, and separation of the fibres provides for improved marinade penetration and reduced marinating time. In examples, the marinade may comprise a liquid, a powder, or a paste. Advantageously, the partial separation of the fibres allows the marinade to penetrate the thickness of the fibrous muscle tissue analogue, providing juiciness and flavour similar to that of meat.

In examples, the method may further comprise applying a binder to the fibrous muscle tissue analogue after separation of the fibres of the fibrous muscle tissue analogue, the binder being configured to set to bind the separated fibres together. For example, the method may comprise applying a binder after compression of the fibrous muscle tissue analogue.

In examples, applying the binder may comprise brushing, spraying, or pouring the binder onto the fibrous muscle tissue analogue. The binder may be applied before or after the marinade. The binder may be combined with the marinade and applied simultaneously. In examples, the binder may comprise a liquid, a powder, or a paste.

Advantageously, the binder acts to bind the separated fibres of the fibrous muscle tissue analogue together, maintaining the integrity of the meat analogue. The binder may also act to seal the marinade and moisture within the meat analogue.

In examples, the binder may comprise one or more cross-linking agents, for example a hydrocolloid, a protein, or a carbohydrate. The cross-linking agent may form cross-links within the meat analogue to bind the fibres together. In examples, the fibrous muscle tissue analogue may comprise the same cross-linking agent as the binder, providing improved binding between the fibrous muscle tissue analogue and the binder.

In examples, the binder may comprise a fat analogue. In examples, the fat analogue may comprise an oleogel, an oil-water emulsion, and/or a hydrocolloid. The fat analogue is preferably white coloured. Advantageously, when the binder comprises a fat analogue the fat analogue is bound between the partially separated fibres of the fibrous muscle tissue analogue, providing a fat analogue analogous to intermuscular fat of animal meat. Combining the binder with a fat analogue can provide a fat marbling effect on the meat analogue.

In examples, the method may further comprise binding a further analogue to the fibrous muscle tissue analogue using a binder.

In examples, the further analogue may comprise a fat analogue. A fat analogue may be bound to the fibrous muscle tissue analogue using a binder, for example the binder detailed above. The fat analogue may comprise a set fat analogue, such as an oleogel, oil-water emulsion, and/or hydrocolloid, such as a hydrocolloid (pr protein) gel. The set fat analogue may be bound to the fibrous muscle tissue analogue in a manner analogous to a line of fat vein or subcutaneous fat of animal meat.

In examples, the fat analogue preferably comprises a cross-linking agent configured to form cross-links with the fibrous muscle tissue analogue and/or the binder. In examples, each of the fibrous muscle tissue analogue, the binder, and the fat analogue comprises the same cross-linking agent, for example the same hydrocolloid, protein, or carbohydrate.

In examples, the method further comprises shaping the fibrous muscle tissue analogue. Shaping the fibrous muscle tissue analogue may comprise retaining the fibrous muscle tissue analogue in an enclosed volume having a defined shape as the binder sets. Accordingly, the shape of the enclosed volume is imparted onto the fibrous muscle tissue analogue. In examples, the fibrous muscle tissue analogue may be pressurised within the enclosed volume. In examples, the confined volume may comprise a mould. The mould may be a spring press mould. Air, for example substantially all of the air, may be expelled from the fibrous muscle tissue analogue before or during being shaped and before binding occurs. In examples, the mould may be stainless steel or aluminium, or polymer. In other examples, the enclosed volume may be a vacuum sealing bag or other flexible container such as a plastic bag.

In examples, the binder is set during shaping. Setting the binder may comprise retaining the fibrous muscle tissue analogue in the enclosed volume for a time until the binder is set. Additionally or alternatively, setting the binder may comprise applying heat and/or cooling to set the binder. In examples the mould may be conductive to permit heat transfer into or out of the fibrous muscle tissue analogue.

In examples, the further analogue comprises a second fibrous muscle tissue analogue. For example, the second fibrous muscle tissue analogue may be the same or similar to the fibrous muscle tissue analogue. The second fibrous muscle tissue analogue may be produced by high-temperature texturisation of a base material comprising a non-animal derived protein, as described above. At least some of the fibres of the second fibrous muscle tissue analogue may be partially separated.

In examples, binding the second fibrous muscle tissue analogue to the fibrous muscle tissue analogue comprises orientating the second fibrous muscle tissue analogue such that the fibres of the second fibrous muscle tissue analogue are substantially parallel to the fibres of the fibrous muscle tissue analogue.

Accordingly, the size of the meat analogue can be increased by binding together two or more fibrous muscle tissue analogues. In examples, layers of fat analogue may be provided between the fibrous muscle tissue analogue and the second fibrous muscle tissue analogue, analogous to intermuscular fat in the meat analogue.

In examples, binding a second fibrous muscle tissue analogue to the fibrous muscle tissue analogue comprises combining the first and second fibrous muscle tissue analogues using a binder. Combining first and second fibrous tissue analogues may comprise rolling, merging, or pressing them together.

In some examples, the method may further comprise rolling the fibrous muscle tissue analogue so as to increase a dimension of the fibrous muscle tissue analogue. A binder may be applied between parts of the rolled fibrous muscle tissue analogue, for example by applying the binder before rolling the fibrous muscle tissue analogue. The rolled fibrous muscle tissue analogue may be shaped after rolling. Advantageously, rolling the fibrous muscle tissue analogue ensures that the fibres remain substantially parallel to each other within the meat analogue.

In examples, the method may further comprise shaping the first and second fibrous muscle tissue analogues. For example, the first and second fibrous muscle tissue analogues may be retained in an enclosed volume having a defined shape as the binder sets so as to impart the shape of the volume onto the meat analogue. In examples, the first and second fibrous muscle tissue analogues may be pressurised within the enclosed volume. In examples, the confined volume may comprise a mould. Air, for example substantially all of the air, may be expelled from the first and second fibrous muscle tissue analogues before or during being shaped and before binding occurs. The mould may be a spring press mould. In examples the mould may stainless steel or aluminium, of polymer. In other examples, the enclosed volume may be a vacuum sealing bag or other flexible container such as a plastic bag.

In examples, the binder is set during shaping. Setting the binder may comprise retaining the first and second fibrous muscle tissue analogues in the enclosed volume for a time until the binder is set. Additionally or alternatively, setting the binder may comprise applying heat and/or cooling to set the binder. In examples the mould may be conductive to permit heat transfer into or out of the fibrous muscle tissue analogue.

In examples, the method may further comprise cutting the fibrous muscle tissue analogue and the second fibrous muscle tissue analogue.

Accordingly, multiple meat analogues can be built up by binding together fibrous muscle tissue analogues, and then the combined meat analogue can be cut into individual portions.

In examples, cutting the fibrous muscle tissue analogue and the second fibrous muscle tissue analogue comprises cutting through a plane that is substantially non-perpendicular to the direction of the fibres.

For example, the cutting may be through a plane that is substantially parallel to the fibres, or at an acute or obtuse angle relative to the fibres. Accordingly, the meat analogue may be formed with fibres oriented in any direction.

In examples, cutting the fibrous muscle tissue analogue and the second fibrous muscle tissue analogue comprises cutting through a plane that is substantially parallel to the direction of the fibres such that the meat analogue comprises fibres extending between major sides of the meat analogue. By binding together the first and second fibrous muscle tissue analogues and then cutting in this manner the thickness of the meat analogue is increased. Such a meat analogue may be analogous to a filet mignon steak, for example.

In examples, the method of binding the second fibrous muscle tissue analogue to the fibrous muscle tissue analogue comprises orientating the second fibrous muscle tissue analogue such that the fibres of the second fibrous muscle tissue analogue are substantially non-parallel to the fibres of the fibrous muscle tissue analogue, for example substantially perpendicular.

Such a method advantageously provides for producing a meat analogue having fibres oriented in different directions in different parts of the meat analogue, permitting a range of different meat analogues to be produced with unique appearances and textures.

In accordance with another aspect of the present disclosure there is also provided a method of producing a meat analogue, the method comprising:
binding a first fibrous muscle tissue analogue to a second fibrous muscle tissue analogue such that the fibres of the fibrous muscle tissue analogue are substantially parallel to the fibres of the second fibrous muscle tissue analogue, and
cutting the fibrous muscle tissue analogue and the second fibrous muscle tissue analogue through a plane that is substantially non-perpendicular to the direction of the fibres.

In examples, binding the first fibrous muscle tissue analogue to the second fibrous muscle tissue analogue may comprise layering, merging, or rolling.

For example, the cutting may be through a plane that is substantially parallel to the fibres, or at an acute or obtuse angle relative to the fibres. Accordingly, the meat analogue may be formed with fibres oriented in any direction in the meat analogue.

In examples, the fibrous muscle tissue analogue and the second fibrous muscle tissue analogue are cut through a plane that is substantially parallel to the direction of the fibres such that the fibres of the meat analogue extend between major surfaces of the meat analogue. Such a meat analogue may be analogous to a filet mignon steak, for example.

In examples, the method comprises binding the first fibrous muscle tissue analogue to the second fibrous muscle tissue analogue using a binder, for example the binder described above.

In examples, the binder may comprise a fat analogue, for example the fat analogue described above.

In examples, the method may further comprise binding a fat analogue to the first fibrous muscle tissue analogue and/or the second fibrous muscle tissue analogue. For example, a fat analogue may be bound to one side of the meat analogue, or between the first and second fibrous muscle tissue analogues. Accordingly, the fat analogue can be provided to the meat analogue to be analogous to intermuscular fat or subcutaneous fat of animal meat.

In examples, the method comprises compressing the first fibrous muscle tissue analogue and the second fibrous muscle tissue analogue to partially separate the fibres of the first and second fibrous muscle tissue analogues before binding the first fibrous muscle tissue analogue to the second fibrous muscle tissue analogue.

As described above, partial separation of the fibres improves the texture of the fibrous muscle tissue analogues, helps the binder penetrate the fibrous muscle tissue analogues, and improves marinating.

In examples, the method may further comprise marinating the first fibrous muscle tissue analogue and/or the second fibrous muscle tissue analogue, for example with the marinade described above.

In examples, the method may further comprise shaping the first fibrous muscle tissue analogue and the second fibrous muscle tissue analogue. Shaping the first and second fibrous muscle tissue analogues may combine the first and second fibrous muscle tissue analogues to each other. For example, the first and second fibrous muscle tissue analogues may be retained in an enclosed volume having a defined shape so as to impart the shape of the volume onto the meat analogue. In examples, the first and second fibrous muscle tissue analogues may be retained in the enclosed volume as the binder sets. In examples, the first and second fibrous muscle tissue analogues may be pressurised within the enclosed volume. Air, for example substantially all of the air, may be expelled from the first and second fibrous muscle tissue analogues before or during being shaped, and before binding occurs. In examples, the confined volume may comprise a mould. The mould may be a spring press mould. In examples, the mould may be stainless steel or aluminium, or polymer. In other examples, the enclosed volume may be a vacuum sealing bag or other flexible container such as a plastic bag.

In examples, the binder is set during shaping. This may comprise retaining the first and second fibrous muscle tissue analogues in the enclosed volume for a time until the binder is set. Additionally or alternatively, setting the binder may comprise applying heat and/or cooling. In examples the mould may be conductive to permit heat transfer into or out of the fibrous muscle tissue analogues.

In accordance with a further aspect of the present disclosure there is also provided apparatus for producing a meat analogue, the apparatus comprising:
a high-temperature texturiser configured to apply heat and pressure to a base material comprising a non-animal derived protein and cause denaturing of the non-animal derived protein and formation of a fibrous muscle tissue analogue; and
a separator adapted to partially separate at least some of the fibres of the fibrous muscle tissue analogue.

Advantageously, the separation of the fibres of the fibrous muscle tissue analogue improves the texture of the meat analogue, making it more similar to that of animal meat, particularly muscle tissue. In addition, separation of the fibres of the fibrous muscle tissue analogue provides for improved marinating, flavouring, and cooking.

In examples, the high-temperature texturiser is configured to apply shear stresses to the base material. In examples, the high-temperature texturiser comprises an extruder or a shear cell.

In examples, the separator comprises one or more rollers adapted to compress the fibrous muscle tissue analogue to partially separate the fibres of the fibrous muscle tissue analogue. The roller may comprise a profiled surface. The profiled surface may comprise one or more cutting blades and/or concave recesses and/or convex recesses. The cutting blades and/or recesses may extend about the circumferential surface of the roller. The profiled surface may act to urge apart fibres of the fibrous muscle tissue analogue in order to partially separate them.

In examples, the separator may comprise a roller and a rigid surface and the fibrous muscle tissue analogue may be passed between the roller and the rigid surface, for example on a conveyor belt. In other examples, the separator may comprise a first roller and second roller spaced from each other such that the fibrous muscle tissue analogue passes between the first and second rollers. A conveyer belt may carry the fibrous muscle tissue analogue between the first and second rollers. In examples, a plurality of rollers (or pairs of rollers) are provided in series to progressively compress the fibrous muscle tissue analogue and partially separate the fibres. In examples, up to 20 rollers (or pairs of rollers) may be provided. Different rollers may have different, or no, surface profile. The rollers may be configured to reduce the thickness of the fibrous meat tissue analogue, for example to between about 0.5 mm and about 10 mm, for example less than about 10 mm, for example less than about 8 mm, for example about 5 mm.

In other examples, the separator comprises a press adapted to press the fibrous muscle tissue analogue.

In examples, the apparatus further comprises an applicator adapted to apply a binder to the fibrous muscle tissue analogue. In examples, the applicator may be a spray applicator, or brush applicator.

In examples, the apparatus further comprises a marinade bath configured to hold a marinade, and wherein the marinade bath is arranged to receive the fibrous muscle tissue analogue after the separator.

In examples, the apparatus further comprises a cutter configured to cut the fibrous muscle tissue analogue.

In accordance with a further aspect of the present disclosure there is also provided a meat analogue comprising:
a fibrous muscle tissue analogue comprising texturised non-animal derived protein, wherein at least some of the fibres of the fibrous muscle tissue analogue are partially separated;
a marinade absorbed into the fibres; and
a binder interspersed between at least some of the fibres.

Advantageously, partially separating the fibres provides for greater penetration of the marinade into the meat analogue, and provision of the binder acts to maintain the integrity of the meat analogue and to retain the marinade and moisture in the meat analogue. Separation of the fibres also improves the texture of the meat analogue, making it closer to that of animal meat.

In examples, the fibrous muscle tissue analogue comprises a generally planar slab or sheet having two major surfaces and side surfaces, and wherein the fibres of the fibrous muscle tissue analogue extend in a direction between the two major surfaces. Accordingly, the fibres are oriented in a vertical direction, analogous to a filet mignon steak or similar.

In examples, the meat analogue further comprises a further analogue bound to the fibrous muscle tissue analogue, for example by the binder.

In examples, the further analogue comprises a fat analogue. Accordingly, a fat analogue may be provided analogous to intermuscular fat or a subcutaneous fat layer of animal meat. The fat analogue may be the fat analogue described above. The fat analogue may be configured to melt during cooking to provide cooking pan lubrication and to simulate the cooking process of animal meat.

In examples, the further analogue comprises a second fibrous muscle tissue analogue. For example, the second fibrous muscle tissue analogue may be the same or similar to the fibrous muscle tissue analogue. The second fibrous muscle tissue analogue may be produced by high-temperature texturisation of a base material comprising a non-animal derived protein, as described above. At least some of the fibres of the second fibrous muscle tissue analogue may be partially separated.

In examples, the fibres of the second fibrous muscle tissue analogue are substantially parallel to the fibres of the fibrous muscle tissue analogue.

Accordingly, the size of the meat analogue can be increased by binding together two or more fibrous muscle tissue analogues. In examples, layers of fat analogue may be provided between the fibrous muscle tissue analogue and the second fibrous muscle tissue analogue, analogous to intermuscular fat in the meat analogue.

In examples, the fibres of the second fibrous muscle tissue analogue are substantially non-parallel to the fibres of the fibrous muscle tissue analogue.

Accordingly, the meat analogue may have fibres oriented in different directions in different parts of the meat analogue, permitting a range of different meat analogues to be produced with different appearances and textures.

In examples, the further analogue comprises a fat tissue analogue. For example, a set fat analogue may be bound to one side of the meat analogue, or between first and second fibrous muscle tissue analogues, analogous to intermuscular fat or subcutaneous fat layer.

### BRIEF DESCRIPTION OF THE DRAWINGS

Embodiments of the invention are further described hereinafter with reference to the accompanying drawings, in which:

FIG. 1 shows a schematic diagram of a method of producing a meat analogue;

FIG. 2 shows a schematic diagram of apparatus for producing a meat analogue;

FIGS. 3 to 9 show various examples of a shear cell apparatus for producing a fibrous muscle tissue analogue;

FIG. 10 shows an example of an extrusion apparatus for producing a fibrous muscle tissue analogue;

FIG. 11 shows a separator and cutting blade of the apparatus of FIG. 2;

FIGS. 12A and 12B show example arrangements of rollers for the separate of the apparatus of FIG. 2;

FIGS. 13A and 13B illustrate a method of producing a meat analogue that comprises two fibrous muscle tissue analogues;

FIGS. 14A and 14B illustrate an alternative method of producing a meat analogue that comprises two fibrous muscle tissue analogues;

FIG. 15 illustrates a fibrous muscle tissue analogue;

FIG. 16 illustrates the fibrous muscle tissue analogue after at least some of the fibres are separated;

FIG. 17 shows a first example meat analogue; and

FIG. 18 shows a second example meat analogue.

### DETAILED DESCRIPTION

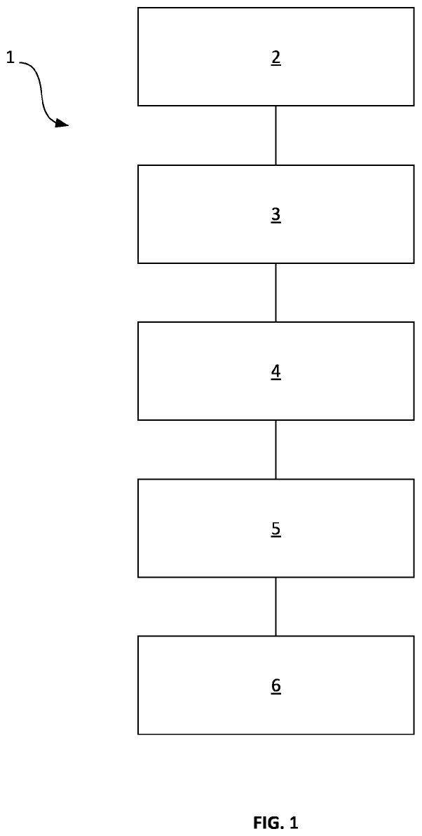

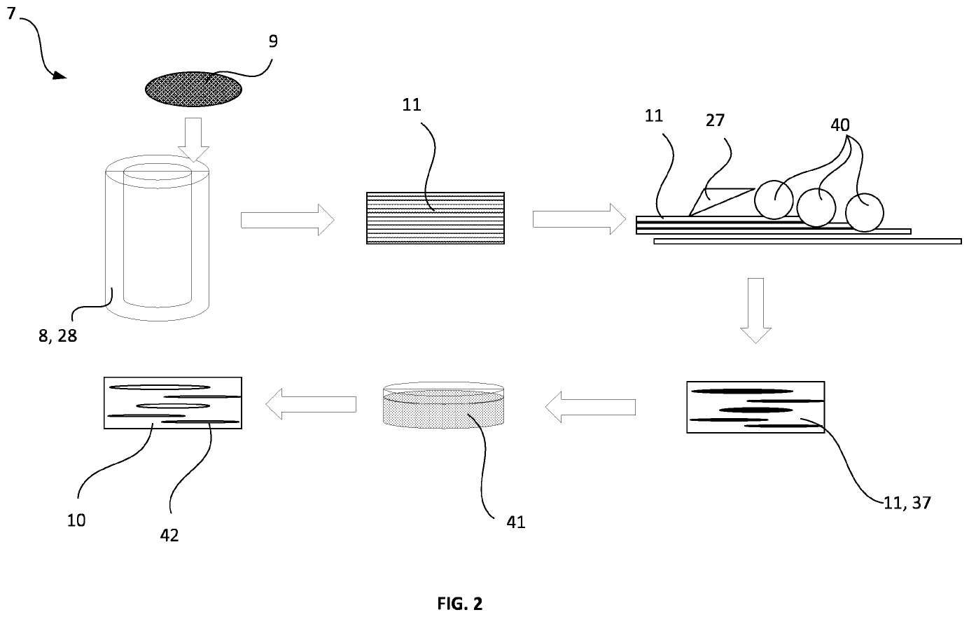

FIG. 1 illustrates a method of producing a meat analogue 1, and FIG. 2 illustrates an example of apparatus 7 for producing the meat analogue 10. As set out in more detail hereinafter, the meat analogue 10 is made from a base material 9 that includes a non-animal derived protein, for example a vegetable protein such as soy protein. The base material 9 is processed, in particular texturised, to create a fibrous muscle tissue analogue 11. The fibrous muscle tissue analogue 11 is then subjected to one or more processes to improve the texture and other characteristics of the meat analogue 10.

As shown in FIG. 1, the method 1 includes forming a fibrous muscle tissue analogue 2. As shown in FIG. 2, the fibrous muscle tissue analogue 11 is made from a base material 9 comprising a non-animal derived protein. In examples, the fibrous muscle tissue analogue 11 is formed by applying pressure and heat to denature the non-animal derived protein and applying shear forces to form fibres.

The base material 9 comprises a non-animal derived protein. In various examples, the non-animal derived protein comprises a plant protein, such as a vegetable protein, in particular soy protein. In other examples, the non-animal derived protein may additionally or alternatively comprise a fungal protein, a protein extracted from a microorganism, or a recombinantly produced protein, for example a recombinant of microbial protein. In examples, the non-animal derived protein comprises microbially produced recombinant protein, for example beef myoglobine produced by genetically engineered Pichia pastoris. In examples, the non-animal derived protein may comprise two or more different non-animal derived proteins.

The non-animal derived protein may be in pure form of protein isolate, or a protein concentrate. In other examples the protein may be a defatted meal with a high protein content, such as soybean meal, providing a protein content of greater than about 55%.

The base material 9 may additionally comprise water. For example, for shear cell structuring the base material 9 may comprise up to about 90% water by weight, for example up to about 80% water by weight, for example about 70%-75% water by weight. In other examples, for high-moisture extrusion the base material 9 may comprise 50-60% water by weight.

In examples, the base material 9 may additionally comprise a fibre, for example pectin or cellulose fibre. In examples, the base material 9 may additionally comprise a carbohydrate, for example starch. Advantageously, addition of a fibre or carbohydrate may help with formation of fibres during the texturisation process.

In examples, the base material 9 may additionally comprise an oil, such a vegetable oil.

In examples, the base material 9 may additionally comprise a hydrocolloid, for example sodium alginate, xanthan gum, carrageenan, gellan gum, konjac glucomannan or similar. Advantageously, providing a hydrocolloid can help with fibre separation for improving the texture of the meat analogue 10 as described further hereinafter.

In examples, the base material 9 may additionally comprise a salt, for example sodium chloride or calcium chloride.

In examples, forming the fibrous muscle tissue analogue 2 may comprise an extrusion process or a shear cell process. These processes apply pressure and heat to the base material to denature the non-animal derived protein and apply shear forces to form the protein into fibres.

During the high-temperature texturisation process the base material 9 may be heated to a “high-temperature” that is greater than the glass transition temperature of the base material 9. In examples of the present invention the “high temperature” may be about 90° C. or higher, depending on the non-animal derived protein used in the base material 9. Preferably, the temperature may be at 90° C. to 170° C., for example 90° C. to 150° C. More preferably the temperature may be at 100° C., 110° C., 120° C., 130° C., 140° C. or 150° C. For example, a 2:1 mixture of vital wheat gluten and soy protein may be heated to about 130° C. In another example, a 9:1 mixture of soy protein isolate and pectin mixture may be heated to about 140° C.

Pressure may be applied mechanically, for example by a screw drive in an extrusion process. Alternatively or additionally, the pressure may be generated by expansion of the base material 9 within a constrained volume, such as in a shear cell. Alternatively or additionally, the pressure may be generated by water vapour created by the heating. For example, water vapour pressure may generate about 3-4 bar of pressure. Heat may be applied directly, for example by heating a part of the texturisation apparatus, and/or heat may be generated by applying pressure and/or shear forces to the base material 9 due to friction.

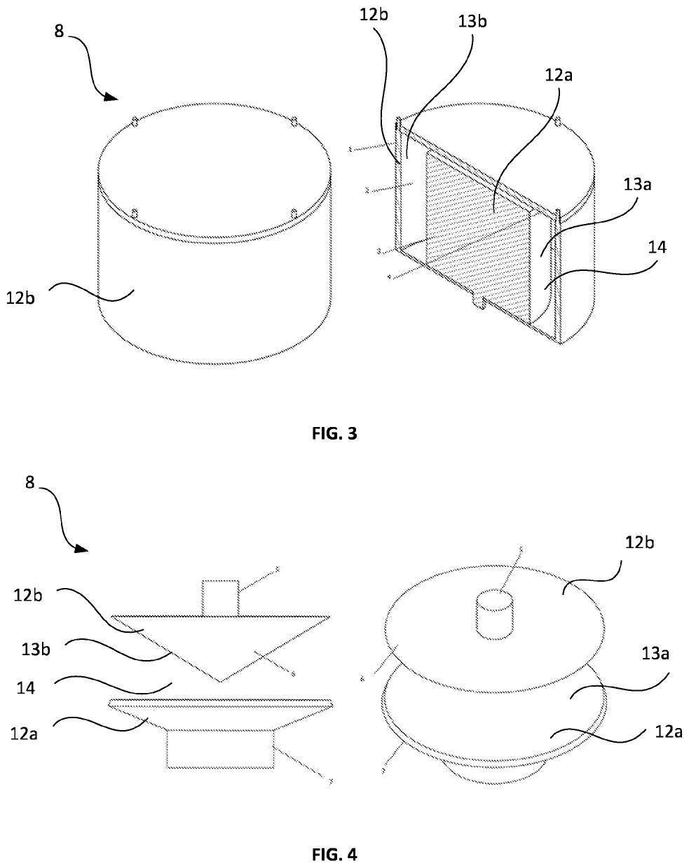

FIGS. 3 and 4 illustrate examples of shear cell apparatus 8 for texturising the base material. FIG. 3 shows the outer form of the shear cell apparatus 8 and also a cross-section through the shear cell apparatus 8. In each example, the shear cell apparatus 8 comprises a first portion 12a defining a first surface 13a and a second portion 12b defining a second surface 13b, wherein the first portion 12a and/or the second portion is rotatable 12b. The base material (9, see FIG. 2) comprising the non-animal derived protein is positioned in the space 14 between the first and second surfaces 13a, 13b, and one or both of the first and second portions 12a, 12b is rotated so as to apply shear forces to the base material between the first and second surfaces 13a, 13b. The first and/or second portions 12a, 12b are heated to apply heat to the base material.

In the example of FIG. 3, the first portion comprises an inner cylinder 12a and the first surface is the outer circumferential surface 13a of the inner cylinder 12a. The second portion comprises an outer cylinder 12b and the second surface is the inner circumferential surface 13b of the outer cylinder 12b. The outer cylinder 12b is concentrically arranged with the inner cylinder 12a and the base material (9, see FIG. 2) is positioned between the first and second surfaces 13a, 13b. One of the inner and outer cylinders 12a, 12b is rotated to apply shear forces to the base material. Alternatively, the inner and outer cylinders 12a, 12b are rotated in opposite directions to apply shear forces to the base material.

In the example of FIG. 4, the first portion comprises a first cone 12a and the first surface is formed on a concave surface 13a of the first cone 12a. The second portion comprises a second cone 12b that corresponds to the first cone 12a and the second surface is the concave surface 13b of the second cone 12b. The second cone 12b is aligned with the first cone 12a and positioned such that the first and second surfaces 13a, 13b oppose each other with a space 14 therebetween. One of the first and second cones 12a, 12b is rotated to apply shear forces to the base material positioned in the space 14. Alternatively, the first and second cones 12a, 12b are rotated in opposite directions to apply shear forces to the base material in the space 14. In examples, the first and/or second cone 12a, 12b may be urged towards the other of the first and second cones 12a, 12b in order to apply a compressive force to the base material in the space 14 during use.

In other similar examples, the shear cell apparatus 8 may comprise opposing first and second planar plates with the first and second surfaces arranged with a space therebetween to receive the base material.

FIG. 5 illustrates a further example of the shear cell apparatus 8 of FIG. 3. In particular, in the example of FIG. 5 an inner wall 15b of the outer cylinder 12b which defines the second surface 13b is removable from the shear cell apparatus 8. The inner wall 15b is mounted by a groove 16 that functions as a keyway and engages a complementary key 17 on the outer cylinder 12b to rotationally couple the inner wall 15b to the outer cylinder 12b.

Similarly, an outer wall 15a of the inner cylinder 12a which defines the first surface 13a is removable from the shear cell apparatus 8. The outer wall 15a includes a key 18 arranged to engage a keyway 19 on the inner cylinder 12a to rotationally couple the outer wall 15a to the inner cylinder 12a.

In this way, an operator can remove the inner wall 15b and the outer wall 15a in order to remove the texturised fibrous meat tissue analogue from the space 14. In addition, removal of the inner and outer walls 15b, 15a allows for cleaning and maintenance of the shear cell apparatus 8. In addition, removal of the inner and outer walls 15b, 15a allows the inner and outer walls 15b, 15a to be changed over, for example to provide a different spacing between the first and second surfaces 13a, 13b to accommodate different amounts of base material and produce fibrous meat tissue analogues having different thicknesses.

Similarly, in the example of FIG. 7 the first cone 12a and second cone 12b have removable surface plates 23a, 23b that comprise the first and second surfaces 13a, 13b. The removable surface plates 23a, 23b of the first and second cones 12a, 12b can be rotationally coupled to the first and second cones 12a, 12b, respectively, by keys 20 and keyways 21. Additionally or alternatively, fasteners 22 may be used to releasably secure the removable surface plates 23a, 23b to the first and second cones 12a, 12b.

In this way, an operator can remove the removable surface plates 23a, 23b in order to remove the texturised fibrous meat tissue analogue from the space 14. In addition, removal of the removable surface plates 23a, 23b allows for cleaning and maintenance of the shear cell apparatus 8. In addition, removal of the removable surface plates 23a, 23b allows the removable surface plates 23a, 23b to be changed over, for example to provide a different spacing between the first and second surfaces 13a, 13b to accommodate different amounts of base material and produce fibrous meat tissue analogues having different thicknesses.

In the example of FIGS. 6, 8 and 9 the first and second surfaces 13a, 13b are profiled, for example engraved. The profile may be provided on one or both of the first and second surfaces 13a, 13b. The profile may include one or more grooves 24a, 24b arranged to increase the shear stress applied to the base material in the space 14 during use and to more efficiently transfer torque to the base material. In the examples of FIGS. 6 and 8 the grooves 24a, 24b are substantially perpendicular to the direction of relative movement of the first surface 13a and the second surface 13b. In the examples of FIG. 9, relating to the shear cell apparats 8 of FIG. 3, the grooves 25 are helical or spiral about the inner cylinder 12a. Such spiral or helical grooves 25 may move the base material in an axial direction of the inner cylinder 12a during use, allowing a continuous process to be provided by feeding base material into the shear cell apparatus 8 at one end and receiving texturised fibrous muscle tissue analogue at the other end. For batch manufacturing, the spiral or helical grooves 25 of FIG. 9 may provide easier insertion of the base material and removal of the texturised fibrous muscle tissue analogue.

It will be appreciated that the grooves 24a, 24b, 25 may be formed on the first or second portions 12a, 12b or on removable parts, such as the removable inner and outer walls 15b, 15a of FIG. 5 or the removable surface plates 23a, 23b of FIG. 7.

In examples, the shear cell apparatus 8 may be sized so as to be usable in commercial kitchens, for example the shear cell apparatus 8 may be sized so as to be used on a worktop. This allows meat analogues to be produced in restaurants and small manufacturing sites and is a significant advantage over larger, commercial apparatus that must be used at a centralised factory due to its size.

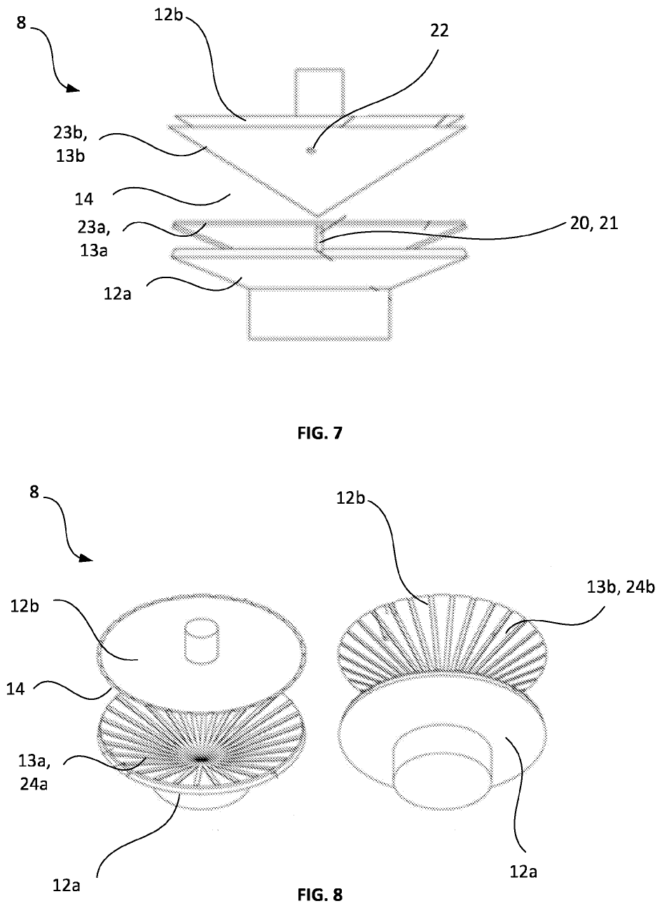

In a shear cell process the outer surfaces of the fibrous muscle tissue analogue 11 may be burned or charred by the application of heat and/or by the friction generated during texturising. Optionally, the outer surface of the fibrous muscle tissue analogue 11 output by the shear cell apparatus 8 can be removed, for example cut away from the fibrous muscle tissue analogue 11. In one example, as shown in FIGS. 2 and 11, the outer surface 26 of the fibrous muscle tissue analogue 11 can be removed by a cutting blade 27 arranged to remove the outer layer 26 of the fibrous muscle tissue analogue 11. In alternative examples, a solution may be used to soften the outer surface 26 of the fibrous muscle tissue analogue 11.

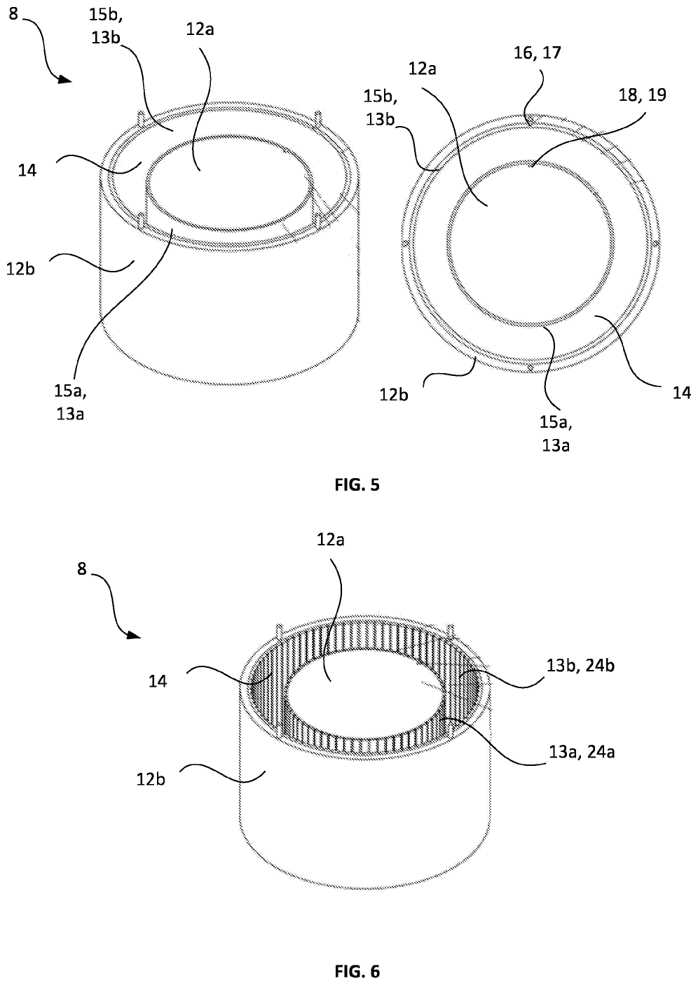

FIG. 10 illustrates extrusion apparatus 28 for texturising the ingredient mix (9, see FIG. 2). As shown, the extrusion apparatus 28 comprises a material feed, in this example a hopper 29, that communicates with a generally tubular barrel 30. The barrel 30 comprises an elongate tube having an inlet 31 corresponding to the material feed 29 and an outlet 32 provided by a die 33. A screw 34, rotatably driven by a motor 35, is positioned in the barrel 30 and acts to push base material from the inlet 31 towards the die 33 and out of the outlet 32. As illustrated, the screw 34 may have a variable pitch screw thread 36 that acts to compress the base material as it moves along the barrel 30. The barrel 30 may be heated. The base material is thereby heated and pressurised in the barrel 30 and forced out of the die 33. The heat and pressure act to denature the protein and as the denatured protein cools and anisotropically gels in the die it forms into a fibrous muscle tissue analogue (11, see FIG. 2). The die 33 is shaped and sized so as to produce a slab of fibrous muscle tissue analogue 11.

In an extrusion process the outer surfaces of the fibrous muscle tissue analogue 11 may be burned or charred by the application of heat and/or by the friction generated during texturising. Optionally, the outer surface of the fibrous muscle tissue analogue 11 output by the extrusion apparatus 28 can be removed, for example cut away from the fibrous muscle tissue analogue 11. In one example, as shown in FIGS. 2 and 11, the outer surface 26 of the fibrous muscle tissue analogue 11 can be removed by a cutting blade 27 arranged to remove the outer layer 26 of the fibrous muscle tissue analogue 11. In alternative examples, a solution may be used to soften the outer surface 26 of the fibrous muscle tissue analogue 11.

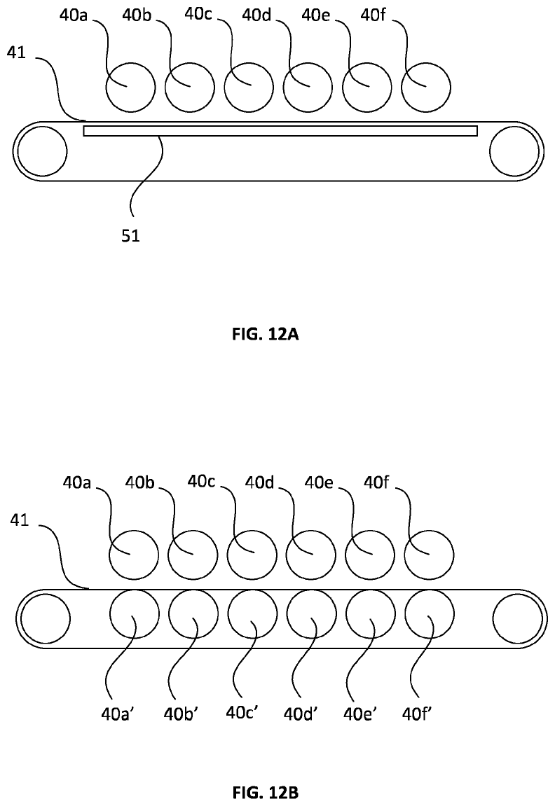

FIG. 14 shows an example of the fibrous muscle tissue analogue 11 produced by a shear cell process in a shear cell apparatus 8 such as those described above. As shown, the fibrous muscle tissue analogue comprises 11 fibres 37 compressed together and generally aligned in the direction of arrow 48. The fibrous muscle tissue analogue 11 has a generally slab form, and the fibres 37 are oriented in a longitudinal direction of the fibrous muscle tissue analogue 11. In particular, the fibrous muscle tissue analogue 11 has major sides 38 that are the larger surface area surfaces, sides 39, and ends 50. The fibres 37 are generally aligned to extend between the ends 50, parallel to the major sides 38 and parallel to the sides 39, in the direction of arrow 48. The orientation of the fibres 37 within the fibrous muscle tissue analogue 11 is determined by the direction of shear forces applied to the base material in the shear cell apparatus 8, or is determined by the direction of extrusion. Accordingly, the fibres of the fibrous muscle tissue analogue 11 are generally aligned.

As shown in FIG. 1, the method 1 further comprises partially separating the fibres (37, see FIG. 14) of the fibrous muscle tissue analogue (11, see FIG. 2) 3. In particular, at least some of the fibres (37, see FIG. 14) of the fibrous muscle tissue analogue (11, see FIG. 2) are partially separated. In examples, at least some of the fibres are only partially separated (i.e., not fully separated) such that the fibrous muscle tissue analogue (11, see FIG. 2) retains an integral form, for example a slab-like form. The fibres may be partially separated by compressing the fibrous muscle tissue analogue to prise apart some of the fibres. Compression acts to separate some of the fibres due to the anisotropic nature of the fibrous muscle tissue analogue in which the fibres are substantially parallel to each other and so more readily separate from each other rather than break fibres.

On output from the texturisation apparatus 8, 28 the fibrous muscle tissue analogue 11 may be highly compressed, with the fibres (37, see FIG. 14) tightly packed and the fibrous muscle tissue analogue 11 having a relatively high density. The fibres are least partially separated to better mimic the texture of meat and improve the cooking and eating characteristics. Moreover, separation of the fibres also provides advantages for marinating and other processes that may be performed to produce the meat analogue, as described below.

In examples, as shown in FIGS. 2 and 11, one or more separation rollers 40 are provided to compress the fibrous muscle tissue analogue 11 in order to partially separate at least some of the fibres (37, see FIG. 14). As shown in FIG. 11, the fibrous muscle tissue analogue 11 may be conveyed on a surface 41, such as a conveyor belt, and at least one separation roller 40 may act to compress the fibrous muscle tissue analogue 11. In examples, a plurality of separation rollers 40 may be arranged to compress the fibrous muscle tissue analogue 11. The plurality of separation rollers 40 may be arranged to apply successively greater amounts of compression to the fibrous muscle tissue analogue 11. The separation roller(s) 40 may be configured to output a fibrous muscle tissue analogue 11a having a desired thickness for the meat analogue 10, or having a desired thickness for a component of a meat analogue 10, as described further below.

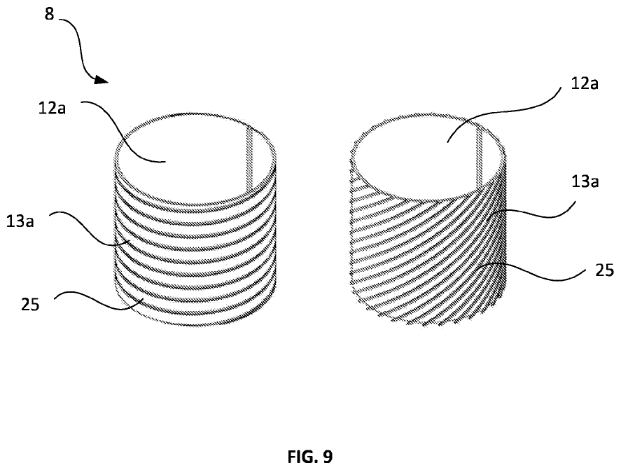

FIGS. 12A and 12B show example separators comprised of multiple rollers 40a-40f. In the example of FIG. 12A a plurality of rollers 40a-40f are arranged above a conveyor belt 41, with a rigid plate 51 disposed within the conveyor belt 41 such that the conveyor belt 41 passes between the rollers 40a-40f and the rigid plate 51. In this arrangement the conveyor belt 41 conveys the fibrous muscle tissue analogue between the rollers 40a-40f and the rigid plate 51. In the example of FIG. 12B a plurality of pairs of rollers 40a and 40a′ to 40f-40f′ are arranged along a conveyor belt 41. Within each pair of rollers 40, 40′ a first roller 40a-40f is arranged above the conveyor belt 41 and an opposing second roller 40a′-40f′ is arranged below the conveyor belt 41. The fibrous muscle tissue analogue is compressed between each pair of rollers 40, 40′ as it is conveyed by the conveyor belt 41.

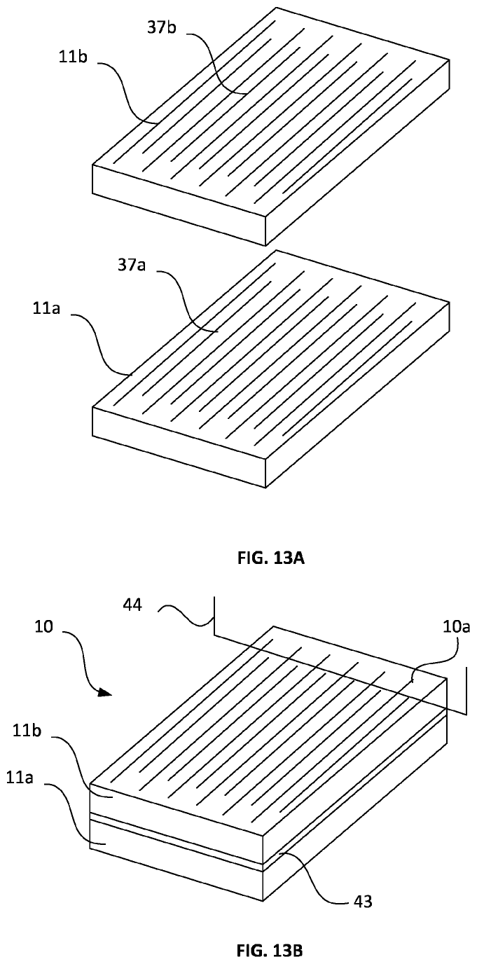

In examples, the separation roller(s) 40 may be profiled. For example, the separation roller(s) 40 may have one or more grooves, knurling, blade, recess, or other profile arranged to contact the fibrous muscle tissue analogue 11 and facilitate separation of the fibres (37, see FIG. 15). The profile of the separation roller(s) 40 may act to partially separate at least some of the fibres (37, see FIG. 15) either while compressing the fibrous meat tissue analogue 11, or without compressing the fibrous meat tissue analogue 11.

In some examples, the separation roller(s) 40 may be profiled to provide separation in specific areas of the fibrous muscle tissue analogue according to the type of meat analogue being produced. For example, for a particular type of steak the separation roller(s) may be configured to separate fibres at a first location on the fibrous muscle tissue analogue and not to separate fibres at a second location on the fibrous muscle tissue analogue in order to better match the texture of the steak to be mimicked. In examples, the separation roller(s) may be configured to create different amounts of fibre separation in different areas of the fibrous muscle tissue analogue.

In other examples, a press may be used to separate fibres of the fibrous muscle tissue analogue. In particular, a press having a plate and an actuator may be used to compress the fibrous muscle tissue analogue against a surface in order to partially separate the fibres. The plate may be profiled, for example knurled or studded like a meat hammer. In other examples, a knife or other cutting edge may be used to partially separate at least some of the fibres of the fibrous muscle tissue analogue.

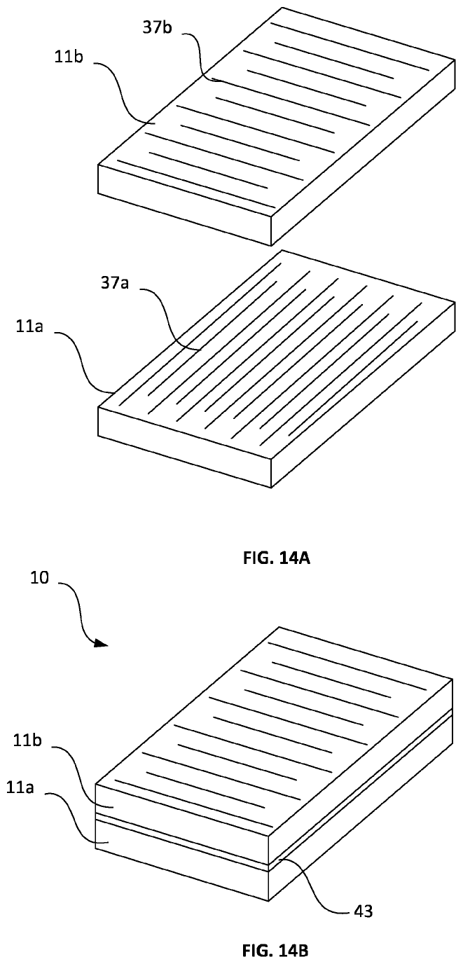

Advantageously, partially separating at least some of the fibres (37, see FIG. 16) of the fibrous muscle tissue analogue 11 greatly improves the texture of the meat analogue (10, see FIG. 2). In particular, separation of the fibres (37, see FIG. 16) makes the texture of the meat analogue (10, see FIG. 2) more similar to that of animal meat. In addition, as explained in more detail below, partial separation of the fibres of the fibrous muscle tissue analogue 11 permits faster and more effective marinating to provide flavours and colouring, and also permits a fat analogue to be applied between the fibres to more closely mimic fat marbling in some animal meats, notably beef.

FIG. 16 shows the fibrous meat tissue analogue 11 after partial separation of at least some of the fibres 37. In this example the partial separation of the fibres 37 has been provided by compression of the fibrous meat tissue analogue 11 shown in FIG. 15. As illustrated, the anisotropy of the fibrous meat tissue analogue 11 causes the fibres 37 to separate unevenly, creating fissures 46 in the fibrous meat tissue analogue 11 where the fibres 37 are partially separated.

As shown in FIG. 1, optionally the method 1 further includes marinating the fibrous muscle tissue analogue 4 after the fibres have been partially separated, for example by the separation rollers 40 described with reference to FIG. 11. Marinating may provide flavour and/or colouring for the meat analogue, particularly for producing a beef meat analogue, a lamb or mutton meat analogue, a chicken meat analogue, a fish meat analogue or a pork meat analogue.

In particular, the fibrous muscle tissue analogue 11 may be marinated by applying, for example spraying or brushing, a marinade on the fibrous muscle tissue analogue 11. In examples, a powder flavour marinade may be applied by rubbing the powder flavour marinade onto the surfaces of the fibrous muscle tissue analogue 11 and between at least some of the separated fibres. Alternatively, the fibrous meat tissue analogue 11 may be marinated by passing the fibrous muscle tissue analogue 11 through a marinade bath 41 as shown in FIG. 2. The fibrous muscle tissue analogue 11 may be kept submerged in a marinade bath 41 for a predetermined time period. In a batch process the fibrous muscle tissue analogue 11 may be placed in the marinade bath 41 for the predetermined time period, or in a continuous process the fibrous muscle tissue analogue 11 may be moved through a marinade bath 41 at a speed that provides submersion in the marinade for the predetermined time.

The fibrous muscle tissue analogue is marinated 4 after separation of the fibres of the fibrous muscle tissue analogue 3. Advantageously, separation of the fibres allows for improved absorption of the marinade into the fibrous meat tissue analogue 11, particular into the fibres (37, see FIG. 15) as there is increased fibre surface area for the marinade to be exposed to. Separation helps to ensure full penetration of the marinade into the fibrous muscle tissue analogue 11 to ensure that substantially the entirety of the fibrous muscle tissue analogue 11 is marinated.

In examples, the marinade may comprise one or more of a colouring, a flavouring, a flavour precursor, a preservative, a spice, and an oil. In examples, particularly for red meat analogues, the colouring may comprise a beetroot-based thermolabile colouring. In examples, the flavourings may comprise a meat flavouring. In examples, the flavour precursors may comprise one or more of an amino acid, a reducing sugar (e.g., ribose), and a vitamin, for example vitamin B12. The flavour precursors may be configured to transform or react during cooking of the meat analogue to release flavours or aromas like those of cooked animal meat. In examples, the marinade may comprise a browning precursor such as lysin, polyphenols (e.g., from apple extract). In examples, the flavour precursor may additionally act as a browning precursor, for example an amino acid or reducing sugar. In examples, the marinade may comprise up to about 90% water. The marinade may be applied to the fibrous muscle tissue analogue 11 in an amount of up to about 10% of the weight of the fibrous muscle tissue analogue 11, for example about 7% of the weight of the fibrous muscle tissue analogue 11. In examples, the marinade may comprise one or more binding components, for example soluble binding components.

As shown in FIG. 1, optionally the method 1 further includes applying a binder 5 to the fibrous muscle tissue analogue. As illustrated in FIG. 1, the binder may be applied after marinating the fibrous muscle tissue analogue 4, but in some examples the binder 5 may be applied before marinating the fibrous muscle tissue analogue 4.

In examples, the binder comprises a fluid (in particular a liquid) that is sprayed or brushed onto the fibrous muscle tissue analogue 11. In other examples, a binder bath may be provided, similar to the marinade bath 41, and the fibrous muscle tissue analogue 11 may be passed through the binder bath to submerge the fibrous muscle tissue analogue 11 in the binder.

In examples, the binder may comprise one or more of a hydrocolloid, a protein, or a carbohydrate. In examples, the binder may comprise the same hydrocolloid, protein, or carbohydrate as provided in the base material 9. In examples, the binder comprises a mixture of a hydrocolloid and a protein isolate in water phase, optionally with oil. The binder may comprise more than 90% water by weight, for example 94% water by weight.

In various examples, the binder may comprise a cold-set binder, for example a sodium alginate solution or a salt mixture solution. A cold-set binder can be set by storing the meat analogue at a cold temperature, for example in a refrigerator at about 4° C., for a period of time to set the cold-set binder. The cold-set binder may be set by cooling the cold-set binder to below about 10° C., for example to between about 2° C. and about 8° C.

In other examples, the binder may comprise a heat-set binder, for example a protein that denatures when heated. In examples, the heat-set binder may comprise a soy protein, egg protein, potato protein, or rubisco. In other examples, the heat-set binder may comprise a hydrocolloid, such as methyl cellulose. In examples where a heat-set binder is used, the meat analogue is heated to set the heat-set binder. The meat analogue may be heated in an oven or a water bath. Heating the meat analogue may advantageously pasteurise the meat analogue, increasing shelf life of the meat analogue. The heat-set binder may be set by heating to about 80° C. or more, for example 85° C., and then cooling to about 5° C. or less, for example about 2° C.

In examples, the binder may alternatively comprise an enzymatic binder such as a transglutaminase enzyme. An enzymatic binder may form enzymatic crosslinking during heat setting. In a particular example, heat setting with an enzymatic binder (e.g., transglutaminase) may comprise a binding phase and a denaturing phase. For example, heat setting may comprise a binding phase of heating to less than 70 degrees Celsius, for example about 50 degrees Celsius, and a subsequent denaturing phase comprising heating to above 70 degrees Celsius, for example about 85 degrees Celsius. During the binding phase the enzymatic binder is activated and acts to bind the fibres together, and in the denaturing phase the enzymatic binder is denatures, leaving an inactive enzyme. In examples, the binding phase may last for about 15 minutes to 1 hour, for example about 30 minutes. In examples, the denaturing phase may last at least 15 minutes, for example about 30 minutes.

In other examples, the binder may additionally or alternatively comprise a konjac glucomannan that may provide a fatty mouthfeel for the meat analogue. Optionally, xanthan gum may be included in the binder to impart additional fatty mouthfeel.

The binder acts to re-join the separated fibres of the fibrous muscle tissue analogue 11 in a manner akin to intramuscular fat and extracellular matrix in animal meat. During cooking of the meat analogue 10 the binder may loosen or soften to mimic the cooking process of animal meat. The binder also acts to seal in the marinade to ensure that the marinade does not bleed out of the meat analogue 10 during storage and transport before and during cooking.

In some examples, the fibrous muscle tissue analogue 11 may be shaped, for example by placing the fibrous muscle tissue analogue 11 in mould and setting the binder. The binder may be set by heating or cooling the mould and the fibrous muscle tissue analogue 11 within. The binder may help to retain the shape of the fibrous muscle tissue analogue 11.

In some examples, the fibrous muscle tissue analogue 11 may be rolled before being shaped and before the binder is set. Rolling the fibrous muscle tissue analogue 11 may increase the thickness of the fibrous muscle tissue analogue 11 while keeping the fibres substantially parallel to each other.

The fibrous muscle tissue analogue 11 with a binder may provide a meat analogue for lean white meats such as a chicken or turkey meat analogue. For a fish meat analogue the fibres may be subject to a greater level of separation and more binder may be provided between the fibres so that on cooking the binder releases the fibres and provides a flaky fish texture.

In examples, the binder comprises a fat analogue. In particular, the binder may comprise one or more of an oleogel (for example ethylcellulose or monoglyceride stabilised oleogel), an oil in water hydrocolloid stabilised emulsion, an oil in water emulsion, a water in oil emulsion, or a white coloured water-based hydrocolloid. The oil may comprise a plant oil, for example sunflower oil, canola oil, or coconut oil.

Advantageously, providing the binder with a fat analogue provides for a fat marbling 42 on the meat analogue 10, as shown in FIGS. 2 and 16. In particular, the binder and fat analogue will penetrate and set in spaces between and around the separated fibres in the fibrous muscle tissue analogue 11, allowing the fat analogue to mimic intramuscular fat of animal meat. Addition of a fat analogue to the fibrous muscle tissue analogue 11 is particularly advantageous for fatty meat analogues such as beef, mutton, lamb and pork meat analogues.

In other examples, the method 1 further comprises applying a fat analogue after applying the binder. The fat analogue may comprise an oleogel (for example ethylcellulose or monoglyceride stabilised oleogel), an oil in water hydrocolloid stabilised emulsion, an oil in water emulsion, a water in oil emulsion, or a white coloured water-based hydrocolloid. The oil may comprise a plant oil, for example sunflower oil, canola oil, or coconut oil. In examples, the fat analogue may additionally or alternatively comprise maillard reaction precursors that release aroma and colour while cooking.

The fat analogue may be applied randomly to the fibrous muscle tissue analogue 11 to provide the marbling effect 42 illustrated in FIGS. 2 and 16. For example, the fat analogue may be applied to the fibrous muscle tissue analogue 11 and then the fibrous muscle tissue analogue 11 can be scraped or brushed to remove some of the fat analogue and leave remaining fat analogue in spaces between the separated fibres near the surface of the fibrous muscle tissue analogue 11.

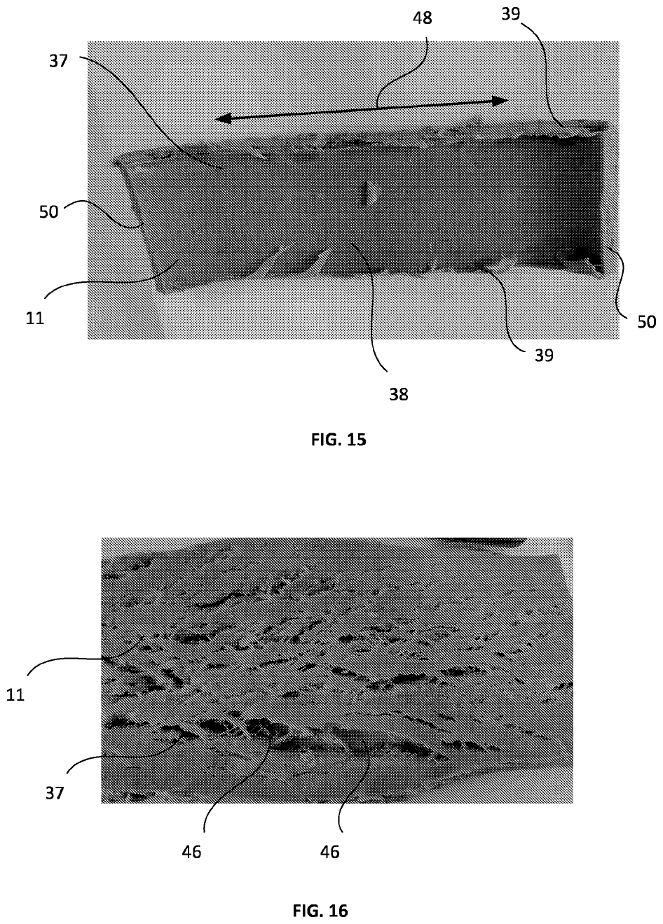

FIG. 17 shows an example of a meat analogue 10 with fat marbling 42. In this example, the fibrous muscle tissue analogue 11 is slab shaped and the fibres are generally orientated in the direction of arrow 47. There is fat analogue 42 provided across some of the surface of the fibrous muscle tissue analogue 11. The fat marbling 42 is provided by the fat analogue between some of the separated fibres of the fibrous muscle tissue analogue 11, and the fat analogue is bound to the fibrous muscle tissue analogue 11 by the binder.

The fat analogue may be configured to melt during cooking, for example at between 50° C. and 200° C. The fat analogue may oxidise during cooking such that degradation of triglycerides provides flavour. The fat analogue may be configured to firmly adhere to the fibrous muscle tissue analogue 11 and/or to the binder. The fat analogue may have the appearance of animal fat, in particular a white/yellow colour and animal fat flavour. The fat analogue may melt during cooking of the meat analogue 10 to lubricate the cooking equipment.

The fat analogue may be applied before the binder has set. The fat analogue may be cold-set or heat-set and penetrate the fibrous muscle tissue analogue 11 in the same manner as the binder, to provide marbling and intramuscular fat between the fibres.

In examples, the fibrous muscle tissue analogue 11, the binder, and the fat analogue comprise the same cross-linking agent to improve binding between the different parts of the meat analogue 10. For example, the cross-linking agent may comprise a protein (e.g., soy protein), a hydrocolloid (e.g., a kappa carrageenan, sodium alginate, konjac glucomannan, or protein, for example soy protein), or carbohydrate (e.g., starch). This provides improved binding between the fibrous muscle tissue analogue 11, binder, and fat analogue by creating crosslinks through the meat analogue. Advantageously, use of kappa carrageenan or sodium alginate in each of the fibrous muscle tissue analogue 11, the binder, and the fat analogue provides a firmer meat analogue 10.

In some examples, the binder or fat analogue may comprise a combination of xanthan gum and konjac glucomannan (e.g., in a ratio of 1:1) can provide a fatty mouthfeel for the meat analogue 10.

The fibrous muscle tissue analogue 11 with binder and fat analogue may provide a meat analogue for fatty meats, for example beef, mutton, lamb or pork. The meat analogue may, for example, be a steak. The meat analogue may be slab shaped with the fibres aligned longitudinally within the meat analogue in the manner of animal meat.

As shown in FIG. 1, optionally the method 1 further includes binding the fibrous muscle tissue analogue to a further analogue 6.

In examples, the further analogue may comprise a second fibrous muscle tissue analogue the same or similar to the fibrous muscle tissue analogue 11, and optionally further fibrous muscle tissue analogues. In examples, the further analogue may comprise a fat tissue analogue. The fat tissue analogue may comprise the same fat analogue as set out above, set to provide a homogenous analogue that can be bound to the fibrous muscle tissue analogue to provide a fat tissue layer on the meat analogue.

In this way, a meat analogue can be assembled from a fibrous muscle tissue analogue 11 and at least one further analogue, for example a further fibrous muscle tissue analogue and/or a fat tissue analogue.

Binding the further analogue 6 to the fibrous muscle tissue analogue 11 may comprise using a binder as described above, which may be set to bind the further analogue to the fibrous muscle tissue analogue. A press may be used to facilitate assembly of the fibrous muscle tissue analogue 11 and the further analogue. The combined fibrous muscle tissue analogue and further analogue may be added to a mould, as described above, and the binder may be set within the mould so as to hold the combined analogues in the desired shape.

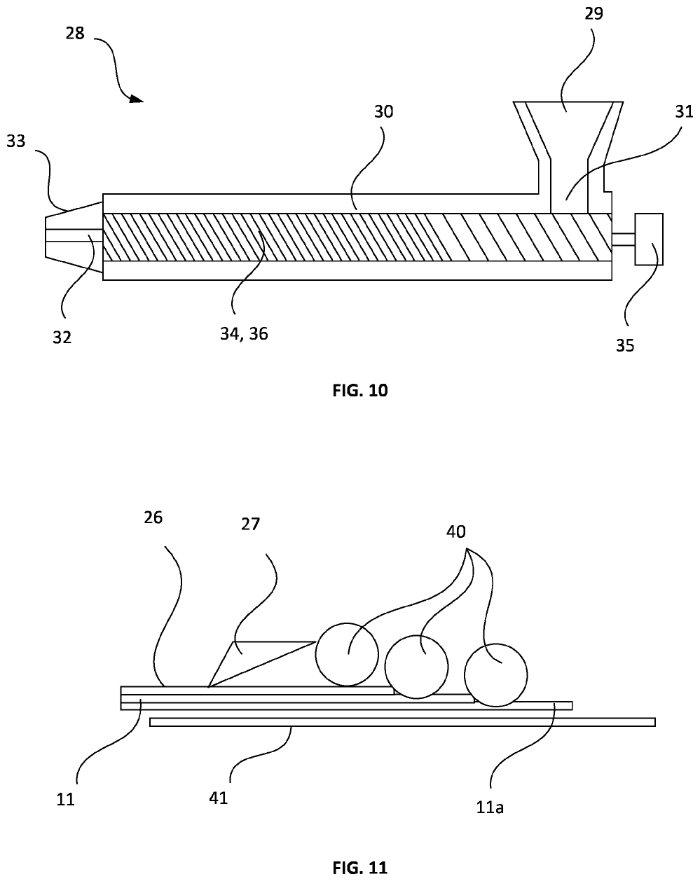

As illustrated in FIGS. 13A and 13B, the method 1 may include binding the fibrous muscle tissue analogue 11a to a further fibrous muscle tissue analogue 11b such that the fibres 37b of the second fibrous muscle tissue analogue 11b are substantially aligned with the fibres 37a of the fibrous muscle tissue analogue 11a. A layer 43 of binder and/or fat analogue and/or fat tissue analogue may be provided between the fibrous muscle tissue analogue 11a and the further fibrous muscle tissue analogue 11b. In this way, a meat analogue 10 can be assembled with layers of fibrous muscle tissue analogue 11a, 11b and optionally intermuscular fat analogue 43.

In some examples, the process illustrated in FIGS. 13A and 13B may be used to produce a fish meat analogue by binding fibrous muscle tissue analogues to each other with a binder adapted to release the binding when cooked and thereby provide a flaky fish meat texture.

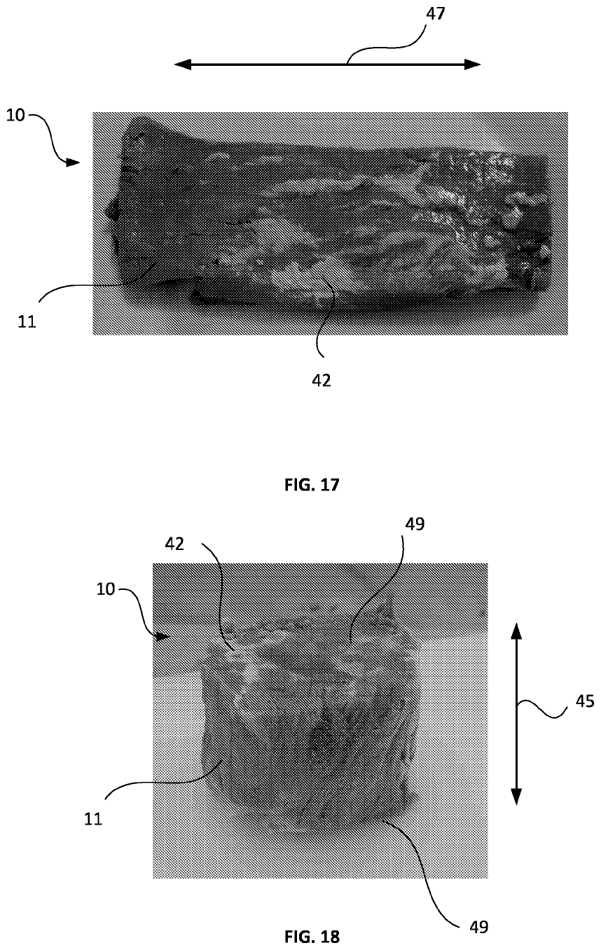

In examples, a plurality of fibrous muscle tissue analogues 11a, 11b may be bound to each other with binder therebetween to assemble a thicker meat analogue 10. In some examples, the meat analogue 10 with a plurality of fibrous muscle tissue analogues 11a, 11 b may then be cut through a plane perpendicular to the fibres 37a, 37b and across the meat analogue 10 (see blade 44 in FIG. 13B) to provide a meat analogue 10a with fibres aligned in a direction between opposing sides of a meat analogue 10a. Such a meat analogue 10 is shown in FIG. 18, where the fibres are generally vertical, in the direction of arrow 45 and between major surfaces 49. This fibre alignment may provide a meat analogue 10 for certain types of animal meat, in particular filet mignon or ribeye steak. The meat analogue 10 of FIG. 18 additionally has fat marbling 42.

As illustrated in FIGS. 14A and 14B, the method 1 may include binding the second fibrous muscle tissue analogue 11b to the fibrous muscle tissue analogue 11a such that the fibres 37b of the second fibrous muscle tissue analogue 11b are substantially non-parallel to the fibres 37a of the fibrous muscle tissue analogue 11a. For example, the fibres 37b of the second fibrous muscle tissue analogue 11b may be perpendicular to the fibres 37a of the fibrous muscle tissue analogue 11a, as illustrated, or at another non-parallel angle, for example 45 degrees. A layer 43 of binder and/or fat analogue and/or fat tissue analogue may be provided between the fibrous muscle tissue analogue 11a and the further fibrous muscle tissue analogue 11b. In this way, a meat analogue 10 can be assembled with layers of fibrous muscle tissue analogue 11a, 11 b and optionally intermuscular fat analogue 43. Accordingly, meat analogues 10 with different orientations of fibres can be provided and so different animal meat analogues can be provided.

In some examples the further analogue may comprise a fat tissue analogue, for example made from a fat analogue as described above and set. The fat analogue may be bound to the fibrous muscle tissue analogue 11a in the same way as the second fibrous muscle tissue analogue 11b as described with reference to FIGS. 13A to 14B.

In examples, the fibrous muscle tissue analogue 11a and further analogue (e.g., second fibrous muscle tissue analogue 11b or fat tissue analogue) may be layered and then rolled to provide unique fibre orientations and texture.

Accordingly, binding a further analogue, for example a second fibrous muscle tissue analogue 11b, to the fibrous muscle tissue analogue 11a can provide meat analogues 10 with unique and customisable fibre orientations and textures, and in a wide range of sizes and dimensions. In examples, the meat analogue 10 may have a thickness of between about 1 centimetre and about 5 centimetres, for example about 3 centimetres or about 4 centimetres. A meat analogue 10 produced by a shear cell method, as described above, may have any length and a width of up to about 10 centimetres. In examples, the meat analogue 10 may have a width of between about 4 centimetres and about 20 centimetres. In a preferred embodiment, a meat analogue may measure 6 cm in diameter and 4 cm thick. In an alternative embodiment, a meat analogue of the invention can be around 14 cm long and 7 to 10 cm wide and 3 cm tall/thick.

The method 1 illustrated in FIG. 1 may also include cutting the meat analogue 10 to provide a meat analogue portion. The meat analogue 10 may be chilled or frozen before it is cut to facilitate easier cutting. The meat analogue 10 can be cut by hand, or by a mechanical cutter such as a shear cutter, a die cutter, or a roller cutter.

The meat analogue 10 provided by the method 1 and apparatus 7 described above is advantageously a whole cut meat analogue 10 with inherent moisture retention and with a fat analogue provided in the manner of animal meat. The meat analogue 10 may have dimensions corresponding broadly to animal meat portion sizes. The texture provided by the process of separating the fibres and then re-binding them using a binder and/or fat analogue.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method of producing a meat analogue, the method comprising:
forming a fibrous muscle tissue analogue by high-temperature texturisation of a base material comprising a non-animal derived protein, the high-temperature texturisation configured to cause denaturing of the non-animal derived protein and formation of substantially parallel fibres in the fibrous muscle tissue analogue; and
partially separating at least some of the fibres of the fibrous muscle tissue analogue.

2. The method of claim 1, wherein forming a fibrous muscle tissue analogue by high-temperature texturisation comprises one of:
extruding the base material through a die, or
shearing the base material in a shear cell.

3. The method of claim 1 or claim 2, wherein partially separating at least some of the fibres of the fibrous muscle analogue comprises compressing the fibrous muscle tissue analogue.

4. The method of claim 3, wherein compressing the fibrous muscle tissue analogue comprises one of:
passing the fibrous muscle tissue analogue through a roller arrangement arranged to compress the fibrous muscle tissue analogue, or
pressing the fibrous muscle tissue analogue using a press.

5. The method of any preceding claim, further comprising marinating the fibrous muscle tissue analogue after separation of the fibres of the fibrous muscle tissue analogue.

6. The method of any preceding claim, further comprising applying a binder to the fibrous muscle tissue analogue after separation of the fibres of the fibrous muscle tissue analogue, the binder being configured to set to bind the separated fibres together.

7. The method of claim 6, wherein the binder comprises a fat analogue.

8. The method of claim 6 or claim 7, further comprising shaping the fibrous muscle tissue analogue.

9. The method of claim 8, wherein shaping the fibrous muscle tissue analogue comprises retaining the fibrous muscle tissue analogue in an enclosed volume having a defined shape as the binder sets.

10. The method of any preceding claim, further comprising binding a further analogue to the fibrous muscle tissue analogue using a binder.

11. The method of claim 10, wherein the further analogue comprises a fat analogue.

12. The method of claim 10, wherein the further analogue comprises a second fibrous muscle tissue analogue.

13. The method of claim 12, wherein binding the second fibrous muscle tissue analogue to the fibrous muscle tissue analogue comprises orientating the second fibrous muscle tissue analogue such that the fibres of the second fibrous muscle tissue analogue are substantially parallel to the fibres of the fibrous muscle tissue analogue.

14. The method of claim 13, further comprising cutting the fibrous muscle tissue analogue and the second fibrous muscle tissue analogue.

15. The method of claim 14, wherein cutting the fibrous muscle tissue analogue and the second fibrous muscle tissue analogue comprises cutting through a plane that is substantially non-perpendicular to the direction of the fibres.

16. The method of claim 15, wherein cutting the fibrous muscle tissue analogue and the second fibrous muscle tissue analogue comprises cutting through a plane that is substantially parallel to the direction of the fibres such that the meat analogue comprises fibres extending between major sides of the meat analogue.

17. The method of claim 12, wherein binding the second fibrous muscle tissue analogue to the fibrous muscle tissue analogue comprises orientating the second fibrous muscle tissue analogue such that the fibres of the second fibrous muscle tissue analogue are substantially non-parallel to the fibres of the fibrous muscle tissue analogue, for example substantially perpendicular.

18. The method of any of claims 10 to 17, further comprising shaping the fibrous muscle tissue analogue and further analogue.

19. The method of claim 18, wherein shaping the fibrous muscle tissue analogue and the further analogue comprises retaining the fibrous muscle tissue analogue and the further analogue in an enclosed volume having a defined shape as the binder sets.

20. A method of producing a meat analogue, the method comprising:
binding a first fibrous muscle tissue analogue to a second fibrous muscle tissue analogue such that the fibres of the fibrous muscle tissue analogue are substantially parallel to the fibres of the second fibrous muscle tissue analogue, and
cutting the fibrous muscle tissue analogue and the second fibrous muscle tissue analogue through a plane that is substantially non-perpendicular to the direction of the fibres.

21. The method of claim 20, wherein the fibrous muscle tissue analogue and the second fibrous muscle tissue analogue are cut through a plane that is substantially parallel to the direction of the fibres such that the fibres of the meat analogue extend between major surfaces of the meat analogue.

22. The method of claim 21 or claim 22, comprising binding the first fibrous muscle tissue analogue to the second fibrous muscle tissue analogue using a binder.

23. The method of claim 22, wherein the binder comprises a fat analogue.

24. The method of any of claims 120 to 23, further comprising binding a fat analogue to the first fibrous muscle tissue analogue and/or the second fibrous muscle tissue analogue.

25. The method of any of claims 20 to 24, comprising compressing the first fibrous muscle tissue analogue and the second fibrous muscle tissue analogue to partially separate the fibres of the first and second fibrous muscle tissue analogues before binding the first fibrous muscle tissue analogue to the second fibrous muscle tissue analogue.

26. The method of any of claims 20 to 25, further comprising marinating the first fibrous muscle tissue analogue and/or the second fibrous muscle tissue analogue.

27. The method of any of claims 20 to 26, further comprising shaping the first fibrous muscle tissue analogue and the second fibrous muscle tissue analogue.

28. The method of claim 27, wherein shaping the first fibrous muscle tissue analogue and the second fibrous muscle tissue analogue comprises retaining the fibrous muscle tissue analogue and the further analogue in an enclosed volume having a defined shape as the binder sets.

29. Apparatus for producing a meat analogue, the apparatus comprising:
a high-temperature texturiser configured to apply heat and pressure to a base material comprising a non-animal derived protein and cause denaturing of the non-animal derived protein and formation of a fibrous muscle tissue analogue; and
a separator adapted to partially separate at least some of the fibres of the fibrous muscle tissue analogue.

30. The apparatus of claim 29, wherein the high-temperature texturiser comprises an extruder or a shear cell.

31. The apparatus of claim 29 or claim 30, wherein the separator comprises one or more rollers adapted to compress the fibrous muscle tissue analogue to partially separate the fibres of the fibrous muscle tissue analogue.

32. The apparatus of claim 31, wherein the roller comprises a profiled surface.

33. The apparatus of claim 29 or claim 30, wherein the separator comprises a press adapted to press the fibrous muscle tissue analogue.

34. The apparatus of any of claims 29 to 33, further comprising an applicator adapted to apply a binder to the fibrous muscle tissue analogue.

35. The apparatus of any of claims 29 to 34, further comprising a marinade bath configured to hold a marinade, and wherein the marinade bath is arranged to receive the fibrous muscle tissue analogue after the separator.

36. The apparatus of any of claims 29 to 35, further comprising a cutter configured to cut the fibrous muscle tissue analogue.

37. A meat analogue comprising:
a fibrous muscle tissue analogue comprising texturised non-animal derived protein, wherein at least some of the fibres of the fibrous muscle tissue analogue are partially separated;
a marinade absorbed into the fibres; and
a binder interspersed between at least some of the fibres.

38. The meat analogue of claim 37, wherein the fibrous muscle tissue analogue comprises a generally planar slab having two major surfaces and side surfaces, and wherein the fibres of the fibrous muscle tissue analogue extend in a direction between the two major surfaces.

39. The meat analogue of claim 37 or claim 38, further comprising a further analogue bound to the fibrous muscle tissue analogue.

40. The meat analogue of claim 39, wherein the further analogue comprises a fat analogue.

41. The meat analogue of claim 40, wherein the further analogue comprises a second fibrous muscle tissue analogue.

42. The meat analogue of claim 41, wherein the fibres of the second fibrous muscle tissue analogue are substantially parallel to the fibres of the fibrous muscle tissue analogue.

43. The meat analogue of claim 41, wherein the fibres of the second fibrous muscle tissue analogue are substantially non-parallel to the fibres of the fibrous muscle tissue analogue

44. The meat analogue of claim 41, wherein the further analogue comprises a fat tissue analogue.
